(19) United States
(12) Patent Application Publication
(10) Pub. No.: US 2024/0289356 A1
(43) Pub. Date: Aug. 29, 2024

(54) STRUCTURED DOCUMENT ACCESS FOR ELECTRONIC DOCUMENTS

(71) Applicant: VIRGINIA TECH INTELLECTUAL PROPERTIES, INC., Blacksburg, VA (US)

(72) Inventors: Edward A. Fox, Blacksburg, VA (US); Aman Ahuja, Blacksburg, VA (US); William A. Ingram, Blacksburg, VA (US); Bipasha Banerjee, Blacksburg, VA (US); Satvik Chekuri, Blacksburg, VA (US)

(21) Appl. No.: 18/585,685

(22) Filed: Feb. 23, 2024

Related U.S. Application Data
(60) Provisional application No. 63/522,917, filed on Jun. 23, 2023.
(60) Provisional application No. 63/522,919, filed on Jun. 23, 2023.
(60) Provisional application No. 63/522,929, filed on Jun. 23, 2023.
(60) Provisional application No. 63/450,149, filed on Mar. 6, 2023.
(60) Provisional application No. 63/448,702, filed on Feb. 28, 2023.
(60) Provisional application No. 63/448,700, filed on Feb. 28, 2023.
(60) Provisional application No. 63/448,159, filed on Feb. 24, 2023.

(51) Int. Cl. G06F 16/28; G06F 16/93

(52) U.S. Cl. CPC G06F 16/287; G06F 16/93

(57) ABSTRACT

Various examples are provided related to structured document access. In some examples, a structured documentation access service identifies a structured documentation request, processes structured documentation or electronic documents according to user selected options specified in the request, and generates a user interface to include subsection files, subsection summaries, object data including image-based objects and text-based objects, a result of an experiment defined by the request, or any combination thereof.

### CROSS REFERENCE TO RELATED APPLICATIONS

This application claims priority to and the benefit of each of the following, including U.S. Provisional Application No. 63/448,159, filed on Feb. 24, 2023, and entitled “STRUCTURED DOCUMENT ACCESS FOR ELECTRONIC DOCUMENTS,” U.S. Provisional Application No. 63/448,700, filed on Feb. 28, 2023, and entitled “OBJECT DETECTION FOR ELECTRONIC DOCUMENTS,” U.S. Provisional Application No. 63/448,702, filed on Feb. 28, 2023, and entitled “CLASSIFICATION AND SUMMARIZATION FOR ELECTRONIC DOCUMENTS,” U.S. Provisional Application No. 63/450,149, filed on Mar. 6, 2023, and entitled “STRUCTURED DOCUMENT ACCESS FOR ELECTRONIC DOCUMENTS,” U.S. Provisional Application No. 63/522,917, filed on Jun. 23, 2023, and entitled “OBJECT DETECTION FOR ELECTRONIC DOCUMENTS,” U.S. Provisional Application No. 63/522,919, filed on Jun. 23, 2023, and entitled “CLASSIFICATION AND SUMMARIZATION FOR ELECTRONIC DOCUMENTS,” and U.S. Provisional Application No. 63/522,929, filed on Jun. 23, 2023, and entitled “STRUCTURED DOCUMENT ACCESS FOR ELECTRONIC DOCUMENTS,” all of which are hereby incorporated herein by reference in their entireties.

### STATEMENT REGARDING FEDERALLY SPONSORED RESEARCH OR DEVELOPMENT

This invention was made with government support under grant no. LG-37-19-0078-19 awarded by the Institute of Museum and Library Services. The Government has certain rights in the invention.

### BACKGROUND

Electronic documents of all kinds can be of immense value to the scholarly community. For example, many Electronic Theses and Dissertations (ETDs) are now publicly available online over public and private local and wide area networks, often through one of many digital libraries. However, since a majority of these digital libraries are institutional repositories with an objective being content archiving, they often lack end-user services needed to make this valuable data useful for the scholarly community. To effectively utilize such data to address the information needs of users, digital libraries should support various end-user services such as document search and browsing, document recommendation, as well as services to make navigation of electronic documents easier.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 illustrates an example networked environment for structured document access in accordance with various embodiments of the present disclosure.

FIG. 2 illustrates an example of a structured document processing and management system in accordance with various embodiments of the present disclosure.

FIG. 3 illustrates an example of object detection for structured document access, in accordance with various embodiments of the present disclosure.

FIG. 4 illustrates another example of object detection for structured document access, in accordance with various embodiments of the present disclosure.

FIG. 5 illustrates an example of subsection identification and generation for structured document access, in accordance with various embodiments of the present disclosure.

FIGS. 6A-6B illustrate examples of user interfaces for structured document access, in accordance with various embodiments of the present disclosure.

FIG. 7 illustrates a flowchart of a service that provides structured document access, in accordance with various embodiments of the present disclosure.

FIG. 8 illustrates a flowchart of object detection for structured document access, in accordance with various embodiments of the present disclosure.

FIG. 9 illustrates a flowchart of subsection classification and summarization for structured document access, in accordance with various embodiments of the present disclosure.

### DETAILED DESCRIPTION

Disclosed herein are various examples related to structured documentation access for electronic documents. It should be understood that “structured documentation access for electronic documents” refers to access to electronic documents and/or to structured electronic document data associated with electronic documents. In various examples, a structured documentation access user interface service is generated to include an interface that identifies a user request for structured documentation from electronic documents. A request to access the structured documentation is transmitted and a subset of the structured documentation is retrieved based on the request. In various examples, the subset of the structured documentation is processed based on user selected options specified in the user request for structured documentation. In various examples, a variety of different types of users can make different types of user requests. The user interface is updated to include structured documentation that can include any one or more of: subsection (e.g., chapter) files, subsection summaries for subsection files, object data such as image-based objects and text-based objects from the electronic document, and a result of at least one experiment or user-requested manipulation defined by the user request. In various examples, the services for users can include search, browse, recommend, and visualize operations. In various examples, the services for users can include content curation and data science experimentation. In various examples, structured documentation access is requested through one or more Application Programming Interfaces (APIs).

Object detection for structured documentation access can include processing of an electronic document using an object detection process. In various examples, an electronic document that includes unlabeled data is identified. Object parsing is performed to identify objects that include a plurality of image-based objects, and a plurality of text-based objects. In various examples, the parsing includes analyzing the image and/or text versions of individual pages of a document. In various examples, the parsing employs an object detection model. In various examples, the object detection model is trained with labeled image versions of individual pages of a document. In various examples, an AI-aided annotation framework is used to annotate image versions of pages extracted from electronic documents, to reduce the human time and labor required in annotation. In various examples, annotations are used to assign labels to detected objects that are used in training an object detection model. In some examples, refined objects are generated by performing at least one modification to at least one of the plurality of objects. In various examples, the refined objects can include subsections, figures, tables, captions, headings, equations, and references. An output can include image files corresponding to the image-based objects, a set of human-readable attribute-value based data structures corresponding to the image-based objects, another set of attribute-value based data structures corresponding to the plurality of text-based objects, and a hierarchical structure file based on the various detected objects. In various examples, a final output can include an XML file together with a plurality of detected objects. The output can be provided in a number of ways, including through a website or other user interface, a programmatic interface such as an API through which the output can be requested and returned as a data transmission, by transmitting the output to a predetermined network location, and/or by storage in a database or datastore. In various examples, output can be rendered in a user interface such as in a browser, yielding a more accessible version of the document, e.g., using HTML, that allows easy navigation and/or is helpful for those with low vision.

Classification and summarization for structured documentation access can include processing of an electronic document using one or more process that performs classification and/or summarization. Disclosed herein are various examples related to classification and summarization for electronic documents that employ fixed-page data (e.g., data in fixed-page-layout format) such as portable document format (PDF) or other formats that can be converted to images, PDFs, or other fixed-page data. In this context, PDF can be considered a file format, while fixed-page-layout can refer to an image file or any type of data or file format that maintains one or more objects such as text, images, equations, tables, and so on as a set of prearranged or fixed pages that include one or more of the objects in a predetermined or fixed spatial relationship on a respective page and/or across multiple pages. The methods that leverage textual information also can be applied to documents that employ markup languages like XML. In various examples, the documents can include scholarly long documents, books, and other electronic documents. For example, while the discussion can include application of certain methods and processes to Electronic Theses and Dissertations (ETDs), the concepts can also be applied to books and other documents that can be separated into subsections.

In various examples, textual data can be identified from page images of an electronic document (e.g., using Optical Character Recognition (OCR) techniques). In various examples, textual data can be identified directly from an electronic document. A classification model can utilize textual information and/or page images to generate a page classification label that associates each page of the electronic document with a classification label selected from a set of predetermined classification labels. A subsection boundary (detection) process, e.g., segmentation, can identify subsection boundaries, e.g., using the information accessed from the page classification label data structure. A subsection boundary process can identify subsection boundaries using the textual data identified from an electronic document. An output can be provided to include a number of subsection files that are generated using the textual data and the plurality of subsection boundaries, or the page images of an electronic document. The subsection boundaries can aid in subsection-level classification and summarization.

In various examples, a subsection subject classification model assigns a label to each subsection based on a predefined classification label. Classification at a subsection-level can be used to demonstrate the interdisciplinary nature of work in a document. A classification label can be provided with the output. A subsection summary can be generated for each of the subsection files and provided with the output. The subject classification and summarization can be performed using textual information from the whole and/or parts of the documents-such as chapters or other subsections.

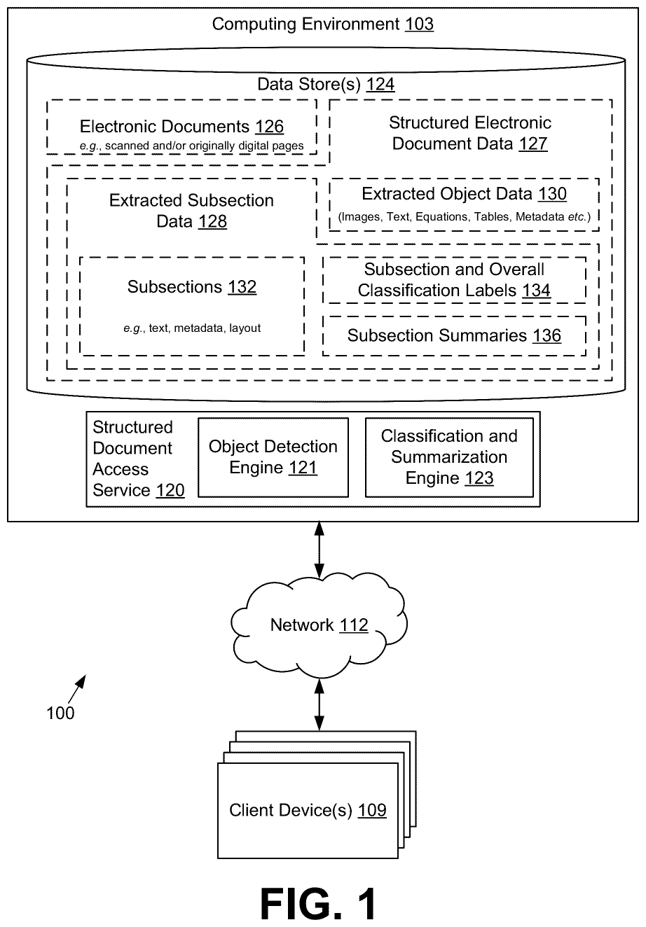

Referring next to FIG. 1, shown is an example implementation according to embodiments of the disclosure. In FIG. 1, shown is a networked environment 100 that implements structured document access by processing and management of the various documents. The networked environment 100 can include a computing environment 103 and client devices 109, which can be in data communication with each other via a network 112.

The computing environment 103 can include one or more computing devices that can respectively include a processor, a memory, and/or a network interface. For example, a computing environment 103 can be configured to perform computations on behalf of other computing devices 103 or applications. As another example, such computing devices 103 can host and/or provide content to other computing devices in response to requests for content. There may be one or more central processing units, graphics processing units, tensor processing units, or other similar processors. Moreover, the computing environment 103 can refer to a plurality of computing devices that can be arranged in one or more server banks or computer banks or clusters or other arrangements. Such computing devices can be located in a single installation or can be distributed among many different geographical locations. For example, the computing environment 103 can include a plurality of computing devices 103 that together can include a hosted computing resource, a grid computing resource, a container cluster, or any other distributed computing arrangement. In some cases, the computing environment 103 can correspond to an elastic computing resource where the allotted capacity of processing, network, storage, or other computing-related resources can vary over time. The computing environment 103 can include a structured document access service 120, an object detection engine 121, and a classification and summarization engine 123, among other executable applications and services.

The client device 109 is representative of a plurality of client devices 109 that can be coupled to the network 112. The client device 109 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, medical equipment or other devices with like capability. The client device 109 can support speech-based applications. The client device 109 can include one or more displays such as liquid crystal displays (LCDs), gas plasma-based flat panel displays, organic light emitting diode (OLED) displays, electrophoretic ink (“E-ink”) displays, projectors, or other types of display devices. In some instances, the displays can be a component of the client device 109 or can be connected to the client device 109 through a wired or wireless connection.

The client device 109 can be configured to execute various applications such as a client application or other applications. The client application can be executed in a client device 109 to access network content served up by the computing device(s) 103 or servers, thereby rendering a user interface on a display of the device. To this end, the client application can include a browser, a dedicated application, or other executable, and the user interface can include a network page, an application screen, or other user mechanism for obtaining user input. The client device 109 can be configured to execute client applications such as browser applications, chat applications, messaging applications, email applications, social networking applications, question-answering applications, word processors, spreadsheets, or other applications.

The network 112 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 112 can also include a combination of two or more networks. Examples of networks can include the Internet, intranets, extranets, virtual private networks (VPNs), and similar networks.

Various data is stored in a datastore 124 that is accessible to the computing environment 103. The datastore 124 can be representative of a plurality of datastores 124, which can include relational databases or non-relational databases such as object-oriented databases, hierarchical databases, knowledge graphs, hash tables or similar key-value datastores, as well as other data storage applications or data structures. Moreover, combinations of these databases, data storage applications, and/or data structures can be used together to provide a single, logical, datastore. The data stored in the datastore 124 is associated with the operation of the various applications or functional entities described below. The data is stored in a datastore 124 that can include electronic documents 126 and structured electronic document data 127, among other items which can include executable and non-executable data. The data that is stored in a datastore 124 can arise from the structured document access service 120, the object detection engine 121, and the classification and summarization engine 123, among other executable applications and services. Structured document access can refer to access involving any of the contents of datastore 124 described herein.

The electronic documents 126 can include documents that are presented in a fixed-page-layout formatting. Fixed-page-layout can refer to data presented in an image file or as any type of data or file format that maintains one or more objects such as text, images, equations, tables, and so on as a set of prearranged or fixed pages that include one or more of the objects in a predetermined or fixed spatial layout on a respective page. The fixed-page layout can preserve the visual appearance and layout across different devices and operating systems. A PDF file, an image file, and other types of files can be formatted to use a fixed-page-layout. A PDF file, and other types of files that can be formatted to use a fixed-page-layout can use a binary format that includes a combination of text, vector graphics, and raster images. The data of a PDF file is not generally considered human readable. Image files can include JPEG, JPG, PNG, GIF, BMP files, and so on. These types of image files can store image data in a binary format, representing pixel values, color information, and other details in a way that is not directly human readable. The electronic documents 126 can be scanned documents where the fixed layout pages are represented as images, or originally-digital documents where the fixed layout pages include images, equations, text, tables, and other types of information. In some examples, the electronic documents 126 can include scholarly long documents, books, and other electronic documents 126. For example, while the discussion can include application of certain methods and processes to Electronic Theses and Dissertations (ETDs), the concepts can also be applied to books and other documents that can be separated into chapters, abstracts, tables of contents, and other types of subsections.

The structured electronic document data 127 can include extracted subsection document data 128 and extracted object data 130, which are extracted from one or more original electronic documents 126. The extracted subsection document data 128 can include subsections 132, as well as respective subsection classification labels 134 and subsection summaries 136 for a respective subsection 132.

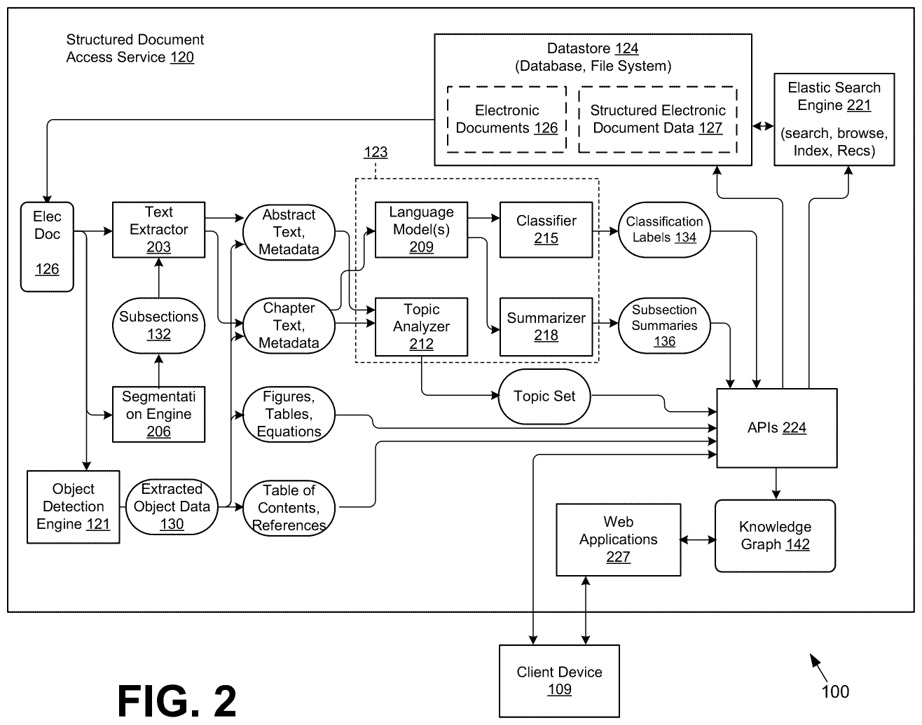

A subsection 132 can generally be stored as a PDF file, image file, or another type of file that can be formatted to use a fixed-page-layout. A set of subsections 132 of an electronic document 126 can be stored in the original format of the electronic document 126 or in another file with fixed-page-layout formatting. The object detection engine 121 and/or the segmentation engine 206 (see FIG. 2) can process an electronic document 126 to generate a set of subsections 132, as described in further detail herein. In some cases, a subsection 132 can be stored in the extracted subsection document data 128 in association with extracted text, metadata describing topics and other information about the text of the subsection 132 (including what other metadata is most utilized), as well as layout data. As a result, a subsection 132 can include a subset of pages of the electronic document 126 in the original layout, and can be stored in association with extracted text (e.g., using optical character recognition), metadata, and other information such as images, equations, and other extracted object data 130.

A subsection classification label 134 can refer to a classification selected from a predetermined set of classifications or types. The classification and summarization engine 123 can identify text extracted from a particular subsection 132, and can process the extracted text to select a particular one of a predetermined set of subsection classification labels 134. The classification and summarization engine 123 can include a machine learning model trained to classify subsection 132 text as a subsection classification label 134 using training data corresponding to each of the classifications or types of subsection classification labels 134. These can refer to one or more disciplines associated with university units (e.g., business, communications, engineering) and subtypes (e.g., electrical engineering, mechanical engineering). The machine learning model can also be trained using human interactions through a user interface of the structured document access system 120, through which a user can enter, modify, confirm, reject, or otherwise provide training feedback data.

A subsection summary 136 can refer to a summary generated using text extracted from a particular subsection 132. The classification and summarization engine 123 can include one or more language model, such as a natural language processing (NLP) model such as a large language model, that processes text extracted from a particular subsection 132 and provided as input to the model. The model can output subsection summary 136. Large language models can include transformer-based models such as a Bidirectional Encoder Representations from Transformers (BERT) based NLP model, a Generative Pre-trained Transformer (GPT) based NLP model such as GPT-3 or GPT-4, and so on. In some examples, the chapter or subsection summary 136 is generated using both unsupervised methods and transformer models that are pre-trained using an initial training dataset. The transformer model can also be iteratively fine-tuned using a training dataset that is specific to theses and dissertations, and can include documents with chapters; and the fine tuning training dataset can include documents specific to or corresponding to each of the classification labels 134 such as university units and subgroups, where documents and classification labels 134 are provided as training inputs. The fine-tuning training dataset can include documents specific to or corresponding to each of the topics in the topic set, where the documents and the associated topics are provided as inputs. An electronic document 126, and subsections 132 thereof, can each be associated with multiple (one or more) classification labels 134 and multiple (one or more) topics.

The extracted object data 130 can include text-based objects and image-based objects. The objects can include text, images, tables, equations, and so on. While in some examples, tables and equations can be stored as image-based objects, the tables and equations can additionally or alternatively be stored as text-based objects. The object detection engine 121 can process an original electronic document 126 and/or a subsection 132 to extract and store the extracted object data 130. The original electronic document 126 and/or a subsection 132 can include original page numbering; the object detection engine 121 can store each item or object of the extracted object data 130 in association with a page number. The subsection 132 can include metadata or other data that indicates a range of page numbers and an electronic document 126 identifier. As a result, the extracted object data 130 can be identified and associated with a particular subsection 132 using the page number and original electronic document 126 identifier. The various items of structured electronic document data 127 can specify one or more page numbers and an electronic document 126 identifier, among other specified data and metadata.

FIG. 2 shows an example of structured document processing using components of the networked environment 100. The structured document access service 120 can include the object detection engine 121, the classification and summarization engine 123, a text extractor 203, a segmentation engine 206, a language model 209, a topic analyzer 212, a classifier 215, a summarizer 218, an elastic search engine 221, APIs 224, web applications 227, and other components. The classification and summarization engine 123 can include and/or utilize the text extractor 203, the segmentation engine 206, the language model 209, the topic analyzer 212, the classifier 215, and the summarizer 218.

Generally, the structured document access service 120 can process electronic documents 126 to generate, and provide user-customized access to, structured electronic document data 127. A user of a client device 109 can interact with user interface elements of a web application 227 to request a particular subset of the structured electronic document data 127, as discussed in further detail below.

The structured document access service 120 can generate user interfaces for the web application 227, including searching and recommending over a collection of electronic documents 126 and related structured electronic document data 127. The structured document access service 120 can include containerized micro services. Examples of containerized micro services of the structured document access service 120 can include •A front-end service that can enable users to enter queries, and shows relevant electronic documents 126 and structured electronic document data 127 corresponding to terms and selected topics, and types of structured electronic document data 127 specified in the request. •A search service that can index and enable search of electronic documents 126 and structured electronic document data 127 according to indexed terms. The search service can log user interactions. •A recommendation service that can build and leverage models which consume user logs as well as electronic documents 126 and related structured electronic document data 127 in order to output recommendations that map characteristics of the current user and their historical searches to other users and their historical searches and preferences to generate the recommendations.

The elastic search engine 221 can index and search over electronic documents 126 and the metadata and other information in the structured electronic document data 127. The structured document access service 120 can include a Representational State Transfer (REST) API that enables the web application 227 to map user interactions with a user interface to logical instructions for the elastic search engine 221, for example, using a Python® programmed Flask or other server. The elastic search engine 221 can use Python® routines and libraries, or other request libraries, to query a “GET DOC” API to receive electronic documents 126 and structured electronic document data 127, including metadata, and the various extracted objects related to the electronic documents 126. A sentence-transformers module with a particular language model 209 can create dense vectors for abstract and title text, and index them into the elastic search engine 221.

The elastic search engine 221 can include: (1) A predetermined configuration of elasticsearch.yml that includes specifications for logging, security, etc.; (2) Using docker-compose.yml to containerize a search cluster so as to run locally; (3) Index templates; (4) SQL queries to query data from a relational database; (5) Code to translate the user queried data from a user-entered format of the web application 227 into a JSON or other appropriate text-based textual format that is compliant with the elastic search engine 221 schema; (6) Code that indexes the data from previous steps; (7) Code that enables updating of indexed documents with new data; (8) Querying the elastic search engine 221 over electronic documents 126, digital objects, and other data of the structured electronic document data 127 to get appropriate results; (9) Dockerfile® that containerizes the code of the previous actions and the elastic search engine 221 itself; (10) Uploading PyTorch® or other machine learning models and frameworks to elastic search engine 221 and using it for text embeddings and vector search; and (11) Employing elastic search engine 221 APIs, which can include and/or interact with the APIs 224.

A content and representation layer includes the datastore 124, along with a repository with database tables (including for metadata) and a file system for larger entities. APIs 224 and/or internal APIs of the datastore 124 can enable accessing and communicating with the repository. In one nonlimiting example presented for illustrative purposes, the datastore 124 can use a PostgreSQL® server with a set of 9 or another number of database tables. One table can be for the electronic documents 126, and another for each version of its metadata and other structured electronic document data 127. There can also be a table for an abstract derived object. Tables associated with structured electronic document data 127 can include: metadata, subsection summaries 136, subsection and overall classification labels 134, and topic sets. Since there can be multiple predetermined schemas or sets of types of topics and classifications, there can be separate tables to specify each of those schemas. A document identifier can be given as a seven digit integer or another type of unique identifier.

In some examples, the datastore 124 can include a hierarchical directory structure, with upper level for collections and lower level for the different electronic documents 126 in a collection. With a sample collection, it suffices to have a three digit number for each source collection, and a four digit number for the different ETDs in a collection. However, any number of digits, alphanumerical tokens, digital tokens, or other types of symbolic identifiers can be used for collections and documents. Each of the electronic documents 126 can have subdirectories for the different types of associated or derived structured electronic document data 127.

The structured document access service 120 can provide APIs 224 to read/write/update/delete records in the database and entries in the file system among other functions. This enables the rest of the system implementation to proceed based on API calls, thus decoupling it from repository operation. A nonlimiting set of specifications for the APIs 224 can be listed in Table 1 for illustrative purposes. The APIs 224 can include another set, in other examples. The personas can refer to classes or types of users that are enabled access to the specified APIs. As a result, an identification of a user, a session, and/or client device 109 can be mapped to a particular persona or role, which can be mapped to a set of actions enabled using specified APIs 224.

TABLE 1
API List.

| Purpose | Method | Description | Persona(s) |
|---|---|---|---|
| Get Statistics Report | GET | Provides statistical reports of the stored ETD collections; | C |
| of School Contribution | | intended mainly for front-end page use. | |
| Amount | | | |
| Get ETD and its Object | GET | Returns all ETDs along with their objects. The “start” and | E R |
| | | “limit” parameters define the pagination function. | |
| Get ETD PDF by etd_id | GET | Returns the ETD PDF by etd_id. | E R |
| Get ETD by etd_id | GET | Returns an ETD corresponding to an etd_id. | E R |
| Get Objects by etd_id | GET | Returns all object details that belong to the ETD. | E R |
| Save Summarization | POST | Takes a JSON object with two fields and values, and inserts | E |
| | | into the summarization table with the associated object_id. | |
| Save Classification | POST | Given a model and set of labels, inserts into | E |
| | | classification tables. Updates object_classification | |
| | | table. label name = class_name. | |
| Get Object Relations | GET | Returns object relations present in the knowledge graph. | R |
| Present in the | | | |
| Knowledge Graph by | | | |
| etd_id | | | |
| Get Object File by | GET | If the type of the object is an image, this API returns | R |
| object_id | | the image file. | |
| Save Object Topic | POST | Takes a JSON body a set of topic terms and the probability | R |
| | | of each term. Saves it in the relevant topic-related table. | |
| Get ETD Page Image | GET | Returns the specific page of the ETD. | R |
| Add New ETD | POST | Adds a new ETD to the database and uploads the file to | C R |
| | | the file system. | |
| Save Detected Object | POST | Saves a PDF/image file into the file system, and inserts | E R |
| | | a row into “object” metadata table with file system | |
| | | path and object type. Returns object_id. | |
| Save Detected Objects | POST | This batch-upload version of the “Save Detected Object” | E R |
| | | API takes a ZIP file and a list of objects in JSON format. | |
| Save ETD Page Images | POST | Saves the generated page images for a particular ETD. | E |
| Save Topic | POST | Saves the generated topic modeling results. | R |
| Modelling Results | | | |

Key for Personas:
C = Curator,
E = Experimenter,
R = Researcher

The APIs 224 in some examples can be grouped as: •Curator Webpage: Help the curator to access the ETDs and perform basic operations like create, read, and update. •Accessing File System: Help access digital objects in the file system. The upload API response is the absolute path. •Accessing SQL Database: Help other developer/curator/experimenter teams to save their results in the database and access existing ETD data. •Logging: Track the users' search queries and the results they click on. User ID and document ID pairs can be found in Search logs, and the service can use this information to generate recommendations.

The logged data can be exposed to a recommendation model through an API. The recommendation system calls the API endpoint with a user ID and can receive the user's history of search queries with the search results they clicked on. While system operations can proceed with code calling APIs, a higher level of abstraction results from running a series of services by calling a workflow that connects them. In one example, Apache Airflow® or another workflow service can be utilized by the structured document access service 120, to execute workflows that are specified as directed acyclic graphs or another appropriate format for the workflow service.

To further simplify the implementation and reduce required clicks for a user, we provide an extensible infrastructure so goals can be interpreted by a reasoner service, which refers to a knowledge graph 142 that associates goals, workflows, and services. To allow no-code specification of the workflows the structured document access service 120 can include a user interface (UI) with screens to describe and connect the goals. Thus, a user such as a researcher can specify the design of a workflow-centric digital library system, according to an in-depth description of the methodology for building an extensible information system. Examples of information goals (in the domain of long document information retrieval, with electronic documents 126 and associated structured electronic document data 127) for a researcher persona can include: (1) extracting full text from PDFs, (2) extracting chapters, (3) extracting tables and figures, (4) classifying chapters into custom categories, etc.

Support for experimenter personas can include: (1) to access training data for their models, (2) a platform to train a machine-learning model to perform object detection and topic modeling, (3) to run experiments using these models and compare their results for optimal use, (4) to offload the results of a trained model to a persistent store, etc. The current digital library system with structured document access service 120 includes workflow implementations for long document Segmentation, Classification, Summarization, Object detection, Indexing, among others.

From the experimenter/curator/content provider's perspective of the structured document access service 120, there can be any number of major components in the system design for the structured document access service 120, including: a cloud server, the datastore 124, the file system, a web application 227 for the curator or other personas, and the corresponding predetermined sets of APIs for the experimenters or other personas. In some examples, each persona or role is provided a separate web application 227 with user interface actions corresponding to the various actions provided for the persona.

TABLE 2

| | Workflows | | Services | | |
|---|---|---|---|---|---|
| Curator | ETD Coration | Usage Statistics | Upload ETDs; | Browse, validate, | ETDs Stats |
| | | | Provide metadata | update ETDs | |
| Researcher | ETD/Chapter | ETD/Chapter | ETD Object | Indexing, Ranking | ETD |
| | Search | Categorization, | Detection | | Summarization |
| | | Topics | | | |
| | ETD/Chapter | | Recommendation | ETD/Chapter | ETD Topic |
| | Recommendation | | | Categorization | Modeling |
| Experimenter | Search for | Get | Run experiment with | UI service to display | Log and display |
| | ETDs/Chapters | recommendation | selected options | the experiment result | results |
| | View documents | User management | Log results with | Run experiment with | |
| | | | timestamps and | selected options | |
| | | | metrics | | |

Table 2 shows three user personas, for which the structured access service 120 can provide three separate sets of functionalities. The personas include curators, researchers, and experimenters. The curator persona can represent those responsible for collecting, managing, and preserving digital collections, and ensuring long term access to electronic documents 126 and associated electronic document data 127. To support their needs, the structured document access service 120 or digital library can provide a suite of collection management tools to allow the curator to organize collections of electronic documents 126 and associated electronic document data 127, as well as create and edit metadata associated with each. The structured access service 120 can provide user interfaces that enable curators to create, upload, and edit electronic documents 126 and associated electronic document data 127 and metadata in batches, as well as one at a time. Curators also track usage and performance, so the system should provide analytical tools to measure and report system usage patterns and other metrics. In this regard, curators can overlap with and/or include those administering graduate programs and those overseeing academic research, i.e., who engage in analysis and reporting; curators can assist them in those activities. Moreover, curators should ensure the long-term preservation of digital assets by monitoring the integrity of digital assets to make sure that none have become altered or corrupted, so that the archive remains trustworthy and accessible. The curator can define and set access restrictions to subsets of electronic documents 126 and associated electronic document data 127 based on user roles and permissions to ensure the privacy and security of sensitive information. The curator also needs to be able to quickly find items in the digital library, so the structured document access service 120 can facilitate advanced search and browse functionality.

The structured document access service 120 can adhere to open standards for interoperability. Finally, the structured document access service 120 can integrate machine learning or AI in support of curatorial tasks, such as automated metadata generation based initially on existing user-entered metadata, format conversion, and machine-generated summaries, keywords, and related works, which could help end users to discover and understand the content (e.g., training a machine learning model using a training set including electronic documents 126 and associated electronic document data 127 and the applied metadata, user-entered relationships between related works, keywords, and so on).

The researcher persona can represent the learners, students, faculty, and community of researchers who use the digital library as facilitated using the structured document access service 120. Most researchers have a background in a specific field of study. They may be working at a university or research institute, or as an independent scholar. Researchers can use a digital library to support their research workflows, which include searching, browsing, reading, and downloading information resources, as well as collecting and analyzing data, and synthesizing findings. They may use tools within the digital library system to annotate items, visualize data, and share data or findings with other researchers. To serve the needs of researchers, the digital library should facilitate advanced search and browse capabilities, e.g., faceted search, results filtering, and NLP. The digital library can adhere to open standards for interoperability and integrate seamlessly with other tools in the research workflow.

The structured document access service 120 can provide a personalized experience, allowing researchers to customize UIs, save search queries and result sets, and get personalized recommendations. Likewise, the structured document access service 120 can provide access controls ensuring secure protection of sensitive information. A structured document access service 120 UI provided for researchers can also include features for data visualization and collaboration among researchers.

We separate the experimenter persona from other researchers due to their unique needs, which partially overlap with that of developer. Experimenters can use the data contained in the datastore 124 for computationally intensive work, such as text and data mining or statistical analysis. To support the needs of experimenters, the structured document access service 120 can support large data sets and high performance computing resources. The structured document access service 120 can support open data interoperability standards to integrate with experimenters' workflows, collaboration, and reproducibility. The structured document access service 120 can provide tools for organizing and managing data and workflows, including version control. Additionally, the structured document access service 120 can provide experimenters with access controls that ensure secure protection of their data, their workflows, and any other sensitive information. Thus, experimenters include data scientists, algorithm developers, system builders, and a broad range of innovators.

The structured document access service 120 can include a Kubernetes® Docker® cluster that orchestrates the containers with PostgreSQL®, Flask®, and other utilized packages. The file system can be mounted from the datastore 124 container, which can include information about the file system location of each electronic document 126 and associated structured electronic document data 127. The web application 227 can enable a workflow for electronic documents 126 processing that runs on a container which can in some cases host the web application 227 that the curator uses, but also can provides the APIs 224 so other users can interact with the datastore 124 and the file system.

The containers of the structured document access service 120 can simultaneously support multiple personas, with whom they interact at different stages. Read and write performance is not affected when the other users are reading or inserting data like object images, chapter summaries, etc. The web application 227 UI can enable curators to access electronic documents 126 and associated structured electronic document data 127 using the UI framework. It includes extended APIs including create, read, update, and delete operations running on the container cluster of the structured document access service 120.

A student or a researcher can access a particular section of interest from an electronic document 126, corresponding to a subset of the structured electronic document data 127 specified in a query and/or other user selections. To do so, the student or a researcher can indicate information about each of the chapters to determine whether the content is of interest. Once a user uploads an electronic document 126, a segmentation pipeline or segmentation engine 206 can predict the chapter boundaries and create extracted subsection document data 128.

Users can use the segmentation pipeline to segment many documents using the model described. Segmented extracted subsection document data 128 can be stored in the datastore 124 and can be used by other services like summarization using a summarizer 218 and classification using a classifier 215. The summarizer 218 and classifier 215 can also use information provided and identified using a language model 209.

In some examples, a parsing and cleaning pipeline, for example, including the text extractor 203 and language model 209, can follow the segmentation engine 206 as shown. The text extractor 203 can be used to extract text from the electronic document 126 and subsections 132 of the extracted subsection data 128. To ensure that the structured document access service 120 only provides text to the downstream services, both tables and figures can be removed from the extracted data, for example, using extracted object data 130 identified and generated using the object detection engine 121.

A deep learning pipeline for the segmentation engine 206 can use both image and text features as sequence elements. In some examples, the segmentation engine 206 can use a Visual Geometry Group model or other convolutional neural network model to extract image features rather than using the object detection engine 121. However, in some examples, this model is, or is part of, the object detection engine 121. Text embedding can also be performed. A Long Short-Term Memory (LSTM) network or other Recurrent Neural Network (RNN), can be trained with extracted features from both text and images. Training and validation can be performed on a training set of electronic documents 126, for example, with an 80-20 split, or other split for training and validation.

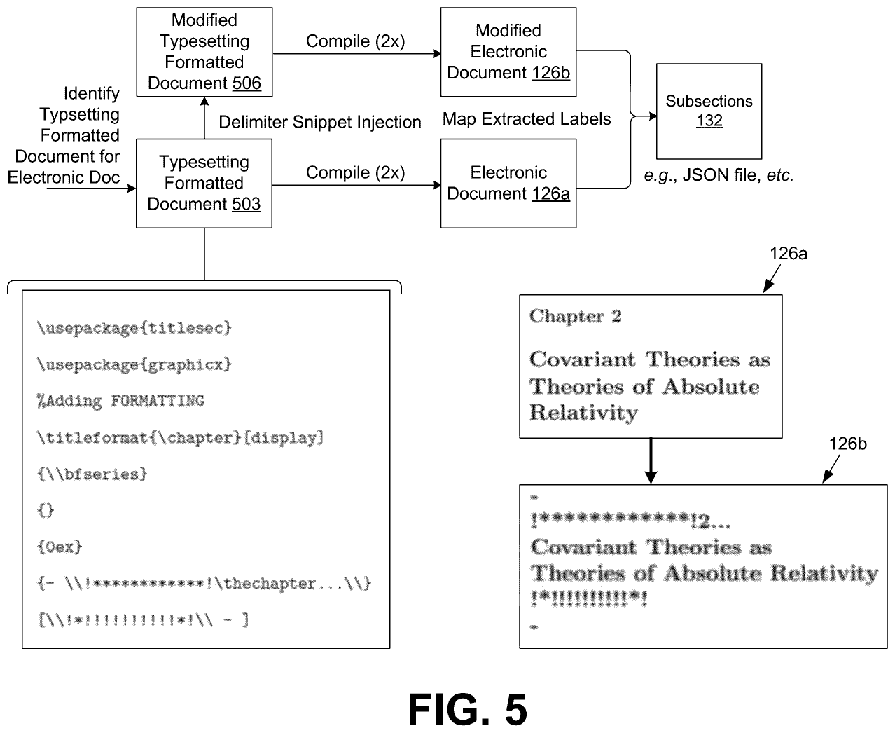

One example model used for the segmentation engine 206 can predict one of six or another predetermined number of labels for, for example, a particular page or a particular subsection 132. In some examples, the segmentation engine 206 can identify a ‘Chapter (or Abstract, or other subsection)’ label (and/or delimiter). The labels can be included in the original document, but a delimiter can, for example, be injected to modify source code such as a TeX file or LaTeX® file for the electronic document 126, as shown in FIG. 5. This can be used to detect chapter boundaries and segment the electronic document 126 into document subsections 132. The text extractor 203 can extract text.

A classification service or classifier 215 (for example, that uses and/or includes the language model 209), can use the extracted chapter text as its input. Chapter classification can be performed using one or both of the full text and the subsection summary as the input. Some of the classification models used for classifier 215 can include (1) Language model-based classifiers-BERT®, SciBERT®, and Longformer®; and (2) Machine learning-based classifiers—for example, Support Vector Machine (SVM) and Random Forest. Chapter text can be used to fine-tune the language models 209. For the classification task, a dataset comprising 27 or another number of predefined classes can be used. The classification evaluation test set can include any number of chapters. The language model 209 and/or classifier 215 can be utilized to generate classification labels 134 on electronic documents 126 and/or structured electronic document data 127; and these can be stored in the datastore 124 as additional structured electronic document data 127.

A summarization pipeline or summarizer 218, which can include or leverage the language model 209, can take the extracted subsection text from the text extractor 203 to generate subsection summaries 136. The summarizer 218 can use language models 209 or other models to perform summarization. Both abstractive and extractive summarization models can be used in some examples.

The summarizer 218 can produce a listing for a set of subsection summaries 136 produced, one for each chapter or other subsection. The structured document access service 120 can store the listing and the subsection summaries 136 in the datastore 124. The subsection summaries 136 can be available for use in tasks such as classification, search, and recommendation provided through the web applications 227 and/or APIs 224. Furthermore, the summarizer 218 for experimenters supports multiple different user-selectable summarization models, which can pre-store multiple summaries or perform summarization on demand from a user interaction.

The object detection engine 121 takes as input a PDF or other fixed-layout format electronic document 126, and produces a parsed version of the electronic document 126, which includes a structured XML format or other text-based format, for example, that is not fixed format. The object detection engine 121 can use object detection models such as YOLO® that have been trained on a dataset consisting of ETD-specific (or other document-type-specific) materials. The fixed-layout format electronic document 126 can be split into individual page images, each of which is then fed to the object detection model for extracting elements on the corresponding pages. More specifically, after creating the page images from the electronic document 126 using a PDF-to-image library, object detection models can extract objects such as the metadata, figures, tables, chapters, and other objects.

A resultant XML or other text-based document can include a plurality of different elements, which in one nonlimiting example can be broadly divided into three or another number of predetermined categories, for example: •Front Matter: includes metadata elements, e.g., document title, author name(s), degree, university, etc. Other elements give an overview of the document, such as the abstract and list/table of contents. •Document Body: is the main part of the document, consisting of a list of chapters. Each can contain respective sections, with their paragraphs, figures (and captions), tables (and captions), equations (with numbers), algorithms, and footnotes. •Back Matter: includes references and appendices. In some examples, the text-based document can include references to a location and/or file corresponding to non-textual data such as images (including in some examples, images of tables, equations, and algorithms, where these or a subset thereof are provided as images rather than text). The content (i.e., text) from text-based objects, such as paragraphs, captions, footnotes, etc. can be extracted using text extraction tools such as OCR, before being populated in the resulting file such as an XML file.

The object detection engine 121 can additionally or alternatively perform a segmentation process, in a different way from the segmentation engine 206. As indicated above, the object detection engine 121 can identify objects and arrange them in a hierarchical data structure such as an XML document. This can include identifying chapter heading objects or other objects that indicate a beginning of a chapter. A page number or page number object can be associated with the chapter heading object, so the beginning boundary page of a chapter or other subsection 132 can be the page that includes the chapter heading object, and the end of the chapter can be the page before the next chapter heading object, and so on. An end of the chapter can also be detected from other types of subsection headings such as a glossary heading object, an abstract heading object, an index heading object, and so on.

As can be seen in FIG. 2, the object detection engine 121 can generate extracted object data 130. This can include the abstract text and metadata, the chapter text and metadata, the figures, tables, and equations (e.g., as image objects), as well as a table of contents and references. However, the segmentation engine 206 and the text extractor 203 can additionally or alternatively provide the textual data such as the abstract text, the chapter text, table of contents, and references among other textual items. A manual or guided user interface can enable users to provide the textual data such as the abstract text, the chapter text, table of contents, and references among other textual items as well as apply appropriate metadata for these items or objects. The classification and summarization engine 123 can use this textual data for its classification and summarization tasks to provide additional valuable information for the textual data that is ingested and processed.

The structured document access service 120 can generate web applications 227 and other user interfaces that enable users to select one of the topic modeling techniques, and the number of topics, and to get the resulting topics of a topic set identified using the topic analyzer 212. This topic analyzer 212 can include components such as: •a Documents per Topic Distribution module: This module helps users find the most popular topics in the document collection. Given a threshold value and a topic, this component calculates the number of documents in the database for which the given topic's probability exceeds a threshold. •Topic List module: For every topic, this module shows the top (e.g., 10) words that are representative of that topic; the set thus serves as a type of label. •Similar Topics module: Some users work in interdisciplinary fields. In such instances, it is often desirable to show a list of related topics to the user. This is done based on similarities between different rows of the topic-word matrix. Other components can also be provided.

The structured document access service 120 can index and search over all the electronic documents 126 and associated structured electronic document data 127 generated, including metadata, figures, chapters, and other extracted object data 130. A researcher can search and browse over a collection of electronic documents 126 and their structured electronic document data 127, across various specified topics and disciplines and collections, and be able to view a list of electronic documents 126 and/or structured electronic document data 127 ranked for relevance to the user query.

The structured document access service 120 can query the database using the APIs 224 provided, and indexes the electronic documents 126 and/or structured electronic document data 127. A micro-web framework can be used to create an API endpoint to receive queries from the front-end web applications 227 and other front end user interfaces. The structured document access service 120 creates a search query and use an elastic search engine 221 to search over the stored index. Inverted index and machine learning based models like k-Nearest Neighbors (kNN) models can be implemented to improve the search, separately, or in various types of combination.

The structured document access service 120 can use different metadata fields like author, university, major, and so on, to sort and filter the search results, according to specified parameters. The structured document access service 120 can also sort the electronic documents 126 and/or structured electronic document data 127 based on an estimated relevance score provided by elastic search engine 221. The elastic search engine 221 logs the user queries and demographics, and makes them available for the recommendation engine to provide user-based recommendations through the user interface. The structured document access service 120 can index at least the following example parameter types into the elastic search engine 221: (1) document metadata which has text fields like author, abstract, title, etc. (2) subsection summaries 136, classification labels 134, and other extracted object data 130 for the subsection or overall document.

The structured document access service 120 can use the following search methods to search over ETD metadata and chapters. •keyword matching to search through the documents. •kNN search, which finds the k nearest vectors to a query vector, as measured by a similarity metric. The indexed documents consist of a field of type dense vector. •a hybrid search method that performs kNN and keyword-based search independently, and then returns top results based on the combined score (e.g., 0.9*match_score+0.1*knn_score). A recommendation module can recommend similar electronic documents 126 and/or structured electronic document data 127 that are recommended as being of potential interest to the user.

The structured document access service 120 can use the recommender model to provide a customized interface by displaying top-n documents in a web application 227 or other user interface. The user click history can be used as a form of feedback to the recommendation system of the structured document access service 120. Click history refers to the log of the electronic documents 126 and/or structured electronic document data 127 that the user has clicked on. The structured document access service 120 can use click events to log user data, and generate a dataset of users and their associated electronic documents 126 and/or structured electronic document data 127. The structured document access service 120 can use this dataset to generate recommendations by training a machine learning model to make the recommendations. For a registered user, the structured document access service 120 can provide a fine-grained recommendation by leveraging that user's interactions and preferences.

The data that is used to build a dataset to train the model can include: (1) User Interaction, (2) Clicks on ETD links, and (3) User Search History (i.e., extracting keywords from each user search query and mapping them to a topic), and other information. The structured document access service 120 can resolve a cold start or lack of information by asking the user upfront about the topics they are interested in. These topics can be the very same topics produced as a result of topic modeling as with topic analyzer 212. The structured document access service 120 can use a Deep Learning Recommendation Model (DLRM) or another model for this purpose. This can provide a hybrid implementation of content and collaborative filtering. The DLRM model can form a global model for recommendations.

The structured document access service 120 can generate recommendations at a user level that can change quickly based on user behavior and usage patterns. It would be difficult to fine-tune a global model for each user. As a result, the structured document access service 120 can train a simple logistic regression model for each user. The user-specific recommendation model provides a click probability per document item (electronic documents 126 and/or structured electronic document data 127) for each user and is then added to that of the global model to generate an integrated model recommendation that can provide the best of both worlds. The structured document access service 120 can identify global knowledge of recommendations through a larger global model and user-level personalization through the smaller user specific model. This integrated recommendation model is exposed as the recommendation service through an ‘infer and train’ API 224. The recommendation service interacts with the front-end web application 227 and elastic search engine 221.

As more people use and interact with the structured document access service 120, the data distribution of the interaction logs can be updated by the service. In order to deliver relevant recommendations to the user, the integrated model is updated with changes in the data. To facilitate easy updates, the structured document access service 120 can provide a ‘train’ API 224 that can be called at a set frequency by the elastic search engine 221.

Segmentation, Classification, and Summarization: The structured document access service 120 can generate an experimenter user interface created to help developers and researchers plug in different models and check the performance. For the experimenter UI, segmentation, classification, and summarization services can be performed in succession. The user has the ability to upload an electronic document 126. This user interface or web application 227 enables the user to select the desired summarization and classification models from a dropdown menu.

For the classification task, a predetermined set of fine-tuned and trained classification models can be shown and selected by user interactions. For summarization, a predetermined set of fine-tuned and trained summarization models currently available can be shown and selected by user interactions. Once a user has made their selection and submitted the form, an API call triggers the workflow to run each of the services using the user-selected models. Then the structured document access service 120 can process the electronic document 126, which is processed as follows. (1) The electronic document 126 can be segmented into chapters or other subsections 132. (2) Subsections 132 can be stored in the datastore 124. (3) Text is extracted and cleaned from the subsections 132 and overall electronic document 126, and stored as text files. (4) Extracted text is fed into the summarization and classification pipelines with the selected models as arguments. (5) Classification labels 134 and subsection summaries 136 are retrieved from respective pipelines and displayed to the user in the UI.

The structured document access service 120 experimenter page can provide the ability to detect and display objects and topics from electronic documents 126 using various selected models. The structured document access service 120 experimenter page can show a predetermined set of object detection models, such as Detectron2®, YOLOv7®, and others, with customization options for model weights and hyper-parameters for each of the predetermined set of models.

The structured document access service 120 experimenter page can choose a model and be redirected to the document view page. The detection results can be displayed in a hypertext markup language HTML page or other appropriate format generated from the object detection's XML or other text-based format output; files can include page specific and overall document XML text-based object data 130, as well as images for certain subset of detected objects. To showcase the detection results of different models on an electronic document 126, a web application 227 or other portion of the structured document access service 120 can produce an HTML page from the object detection model.

The user can choose between the predetermined set of object detection models, and can then upload the desired electronic document 126 in fixed layout format such as PDF for detection. The HTML page displays the detected objects including pages (or chapters or overall text depending on whether segmentation is also performed), figures, and linked captions extracted from the electronic document 126 in an organized manner.

Topic Modeling of electronic documents 126 and subsections 132: The structured document access service 120 experimenter page for topic modeling currently can provide various types of services. An electronic documents 126 embedding API can accept a topic model name, a set of selected topics, and document ID (or electronic document 126 file) as input. It can return a topic vector that represents the probabilities of the document being associated with each of the k topics generated. The Related Documents API, given the model name, number of topics, and document ID (or electronic document 126 file), can output the most relevant electronic document 126 or structured electronic document data 127, with the default value for the optional parameter “top k” being 5 or another predetermined number of related documents or document objects.

The structured document access service 120 can also include a Related Topics API, with the same input parameters as the previous API, can return the most related topics, with a default value for the “top k” parameter of 5 or another predetermined number of related topics.

The structured document access service 120 can also include an interface for the experimenter to create and run search-related experiments. These experiments can allow the experimenter to index custom vectors for each electronic document 126. Once such data is created, the experimenter can perform a hybrid search (e.g., kNN+keyword) on the indexed documents and check the scores for the documents returned. These experiments are user specific, and the created experiments' metadata is stored in a search index. The structured document access service 120 can also provide various default experiments accessible to all users. These involve text embeddings created from the abstract and title of a set of electronic documents 126 processed by the service. Experiments can also involve structured electronic document data 127.

The traditional approach to very long documents is to simply treat them like other documents, and just help find an entire long document. This is what is done by WWW search engines, library catalogs, and scholarly oriented systems and others. However, the structured document access service 120 models apply the use of deep learning related to paper-length documents, including with transformers and attention models, along with the other techniques described herein, and modify them for very long documents (documents that have more pages than a predetermined threshold number of pages). Long documents can be organized into chapters and further into sections that include multiple chapters, or are parts of chapters. They can include a hierarchy of different types of subsections in a parent child relationship. Automatic segmentation of electronic documents 126 can be used to identify a first type of subsections 132, for example, bottom-level subsections such as chapters without child subsections. These subsections 132 are then used for chapter-level (or other subsection-type-level) classification, summarization, and subsequent chapter searches and recommendations. The variation in format, writing structure, and styles can make it difficult to automatically detect chapter boundaries.

However, the structured document access service 120 can include a segmentation model that, as is shown in FIG. 5, identifies and modifies LaTeX® or other document source code (e.g., code that is used to generate the electronic documents 126) to train a segmentation engine 206 or model thereof to predict the chapter boundaries of electronic documents 126. Once trained, segmentation engine 206 can identify subsections 132 of various types without LaTeX code. The modified document source code contains chapter and section tags or delimiters that train the model for boundary detection. The model uses both page images and textual information to detect chapter boundaries, so once trained, LaTeX code, while helpful, is not necessary. University repositories hosting electronic documents 126 can include metadata information. Department or discipline information can be included in the metadata, and stored as structured electronic document data 127. The structured document access service 120 can perform chapter-level classification, such as with subsection summaries 136, and can perform multi-label classification.

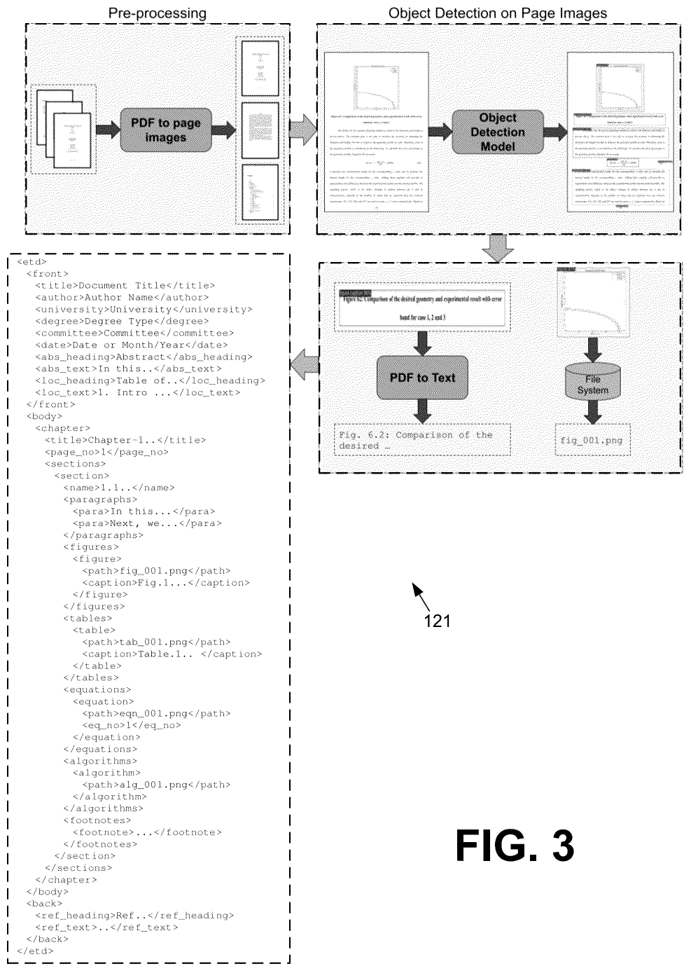

FIG. 3 illustrates an example of the operation of an object detection engine 121 for structured document access. The object detection engine 121 can transform electronic documents 126 into a structured electronic document, for example, in XML format, along with other structured electronic document data 127.

The object detection engine 121 can include the different modules broadly divided into data pre-processing, object detection on page images, and extracting and saving text-based and image-based objects as structured electronic documents (e.g., structured electronic document data 127). Data and Preprocessing can take a PDF or other fixed layout version of an electronic document 126 as input. The input file can be converted to individual page images (e.g., .jpg or other image format) using appropriate libraries such as pdf2image or another conversion from fixed layout document file to a set of page-specific images.

Next, the page images can be individually fed to an Element Extraction module for further processing. The Element Extraction using an Object Detection module takes the individual page images as input, and uses an object detection model such as Faster-RCNN® or YOLO® for object detection. These models can be first pre-trained on a dataset specific to long form documents or another document type (such as novel, thesis, textbook, etc.). The output of object detection can be a list of elements, where each element contains information about the bounding boxes such as the coordinates, along with the category labels and a value indicating confidence in the box coordinates on the page image and/or the object type identified. This process is repeated for all of the pages in the electronic document 126.

A list of pages accompanied by their respective elements can be populated. In some instances, an object detected by the model is classified as one belonging to a different, yet similar object category. In such cases, the system can use post-processing rules to correct the predictions. For example, an abstract heading being mis-classified as a chapter heading can be an error, since both of these elements are often found in bigger font size at the beginning of a page. This can, however, be corrected by enforcing a constraint such as: a chapter heading in the first 10 pages with matching keyword “abstract” will be the abstract heading, for example, once OCR is performed and the term “abstract” is identified. The object detection engine 121 can use a set of such rules for different object types to correct mis-classifications before the objects are sent to the XML module. This can also enable identification of individual objects that span across multiple pages, where the object has multiple parts across multiple pages.

Structuring Objects into XML or another text-based structured hierarchical or markup language format: After extracting all of the elements for all of the pages in the document, the object detection engine 121 can generate an XML or other textual markup representation of the document. The objects can broadly belong to two types. The first type includes image-based objects such as figures, tables, algorithms, and equations, which can be stored on the file system or datastore 124 as image files. In some examples, tables are regarded as image-based objects even though they might contain text, since further extraction of information in structured format from tables can be arduous and error prone. In some examples, the files for object types such as figures, tables, algorithms, and equations can be labelled with a file name that indicates the type as a code, friendly name, or set of human recognizable characters such as an appropriate abbreviation for the object type; this can be provided along with a numerical or other symbolic unique identifier of the object among other objects or a subset of objects belonging to that type.

The second type of object includes text-based elements such as paragraphs, titles, etc., which need further processing to be converted to plain text. Object categories excluding the image-based ones can be textual elements or objects. For converting text-based objects to plain text, we can use off-the-shelf tools and libraries. Some PDF type electronic documents 126 are born-digital, where the text can be easily extracted using Python® or libraries such as pymupdf3 based on page ID and bounding box coordinates. However, other PDF type electronic documents 126 are scanned. For these, the system can use OCR of the image that is cropped and limited to a subset of the page image, based on the coordinates of the bounding box generated for the object. Figures and tables can be mapped to their respective captions based on proximity. For any figure/table element, the caption object closest to the image object based on Euclidean distance with respect to closest pixel, centerpoint-to-centerpoint, or another distance based on respective bounding box coordinates, is identified to be the caption.

A similar process can map equation objects to equation number objects, with an added constraint that the y-coordinate of the center of the equation number should fall between min and max y-coordinates of the equation object. Finally, all the element values (for example, the text object contents and identifiers, as well as image object identifiers, and correlated ‘related objects’ referring to equation numbers for equations, figure number and caption for figures, table number and caption for tables, and so on) are put into the structured document file under their corresponding tags.

An example detailed XML schema is shown in the bottom left image of FIG. 3. The XML file can include a hierarchical listing of this information including relationships between objects. A relationship between an object can be indicated by listing within a particular grouping. For example, FIG. 3 shows that a particular electronic document 126 (or <etd>) includes front matter as indicated within the <front></front> section, a document body indicated in the <body></body> section, and back matter within the <back></back> section. The front matter can include a title, author, university, degree, committee, date, abstract heading, abstract text, table of contents heading, table of contents text, and so on. The body can include one or more chapters, noting that chapters can span multiple pages of the overall document, and so the chapter object can be detected across multiple pages and can include multiple other objects (e.g., subsidiary objects or related objects) such as a title, a starting page number, and ending page number, a section (subsection or child section of a chapter), a paragraph (subsection of the “section”), figures, tables, equations, algorithms, footnotes, and other items associated in a hierarchical structure as shown. Each of these can correspond to types of objects that the object detection models are trained to detect and include in the hierarchical structure within the structured electronic document or XML file. While the text is not shown in entirety, the paragraphs <para></para> and other items can provide all textual data objects of the electronic document 126 within the hierarchical structure, and can reference all of the image data objects.

Object Detection Training can include one or more document type specific training (and validation) sets for training object detection models for the overall object detection framework. The object detection models of the object detection engine 121 can include: •A multi-stage object detection model. This type of model can have two or more stages. A region proposal network generates regions of interest, which are fed to another network for final detection. •A single stage object detection model that performs the processes of localization and detection using a single end-to-end network. This improves the speed without any significant drop in performance.

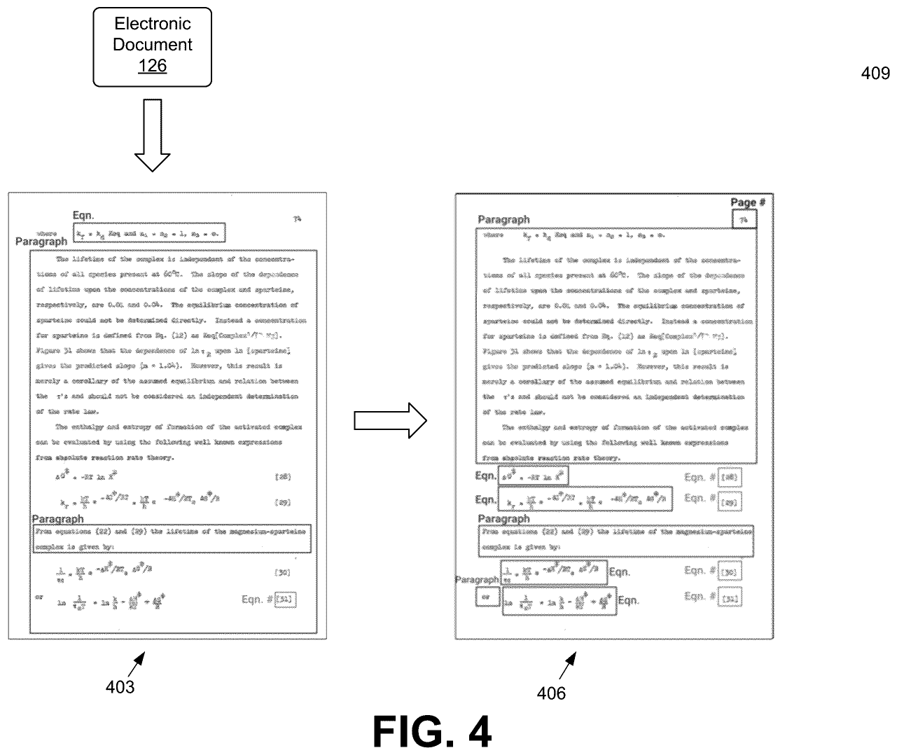

FIG. 4 illustrates another example of the operation of the object detection engine 121 for structured document access. In this example, a particular page of an electronic document 126 is provided as input to the object detection engine 121, generating a raw or machine generated initial processed page 403. The initial processed page 403 can be a direct output from a current version of the object detection model of the object detection engine 121. The initial processed page 403 can include and be associated with data corresponding to detected objects that are defined using bounding boxes and the information including images and/or text within a bounding box. Here, an equation is identified, as well as two paragraphs.

However, the structured document access service 120 can provide a user interface through which the initial processed page 403 can be modified or corrected to generate a corrected processed page 406. The modifications to the bounding boxes and object types of the initial processed page 403 to the corrected processed page 406 can be provided as feedback to further train the object detection model. Any object detection model can be used as a basis for generating the initial processed page 403, and can be further trained using the corrected processed page 406 and the modifications therein, as generated using the described user interface and feedback mechanism of the structured document access service 120 and its object detection engine 121. A drag- and drop UI can enable a user to modify existing bounding boxes, delete bounding boxes, re-classify object types indicated for bounding boxes, create new bounding boxes, and so on.

FIG. 5 illustrates an example of subsection identification and generation for structured document access. This shows how the segmentation engine 206 can use delimiters to more accurately identify subsections 132 based on their subsection (e.g., Chapter) boundaries identified in typesetting formatted documents 503 such as TeX files used to generate PDFs or other layout-formatted electronic documents 126. The segmentation engine 206 can inject boundary delimiters around chapter headings of a typesetting formatted document 503 to generate a modified typesetting formatted document 506. The typesetting formatted document 503 and the modified typesetting formatted document 506 can be used to generate corresponding electronic documents 126. For example, the typesetting formatted document 503 can be used to generate the electronic document 126a, and the modified typesetting formatted document 506 can be used to generate the modified electronic document 126b.

These documents can be provided to a classification model that is trained to generate subsection boundaries as well as classification labels 134 for the corresponding subsections 132. The data can also be processed to identify the delimiters themselves. Since the delimiters can be used as a verification of subsection boundaries, this can help to train the classification model to correctly identify subsection boundaries. However, once trained, in some examples, the classification model can identify boundaries and perform classification into categories even if a Tex file and/or boundaries are not provided directly. That is, in some examples, the electronic documents 126 can be processed alone once the model is trained. The subsections 132 can be used to generate subsection summaries 136 as well, as described with respect to FIG. 2.

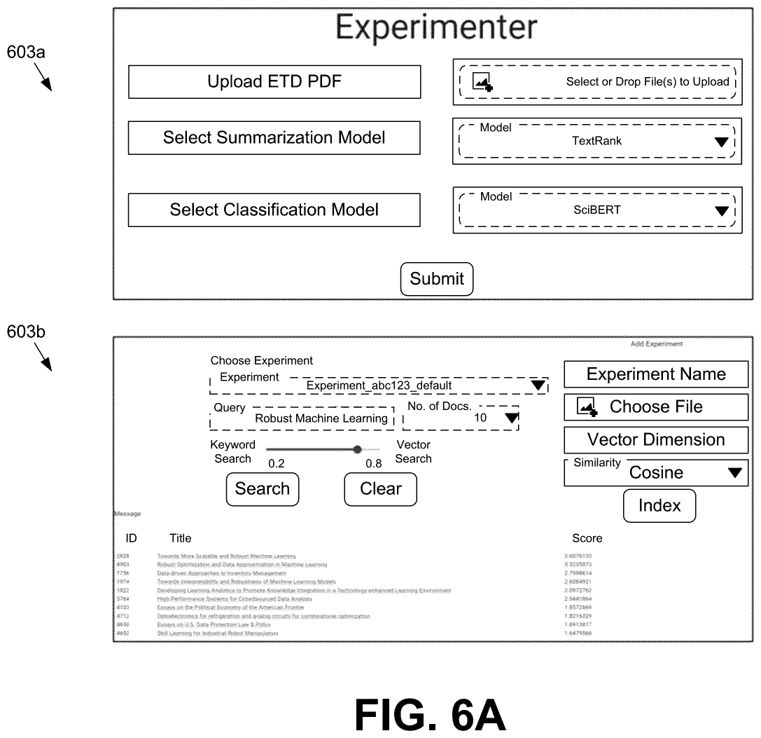

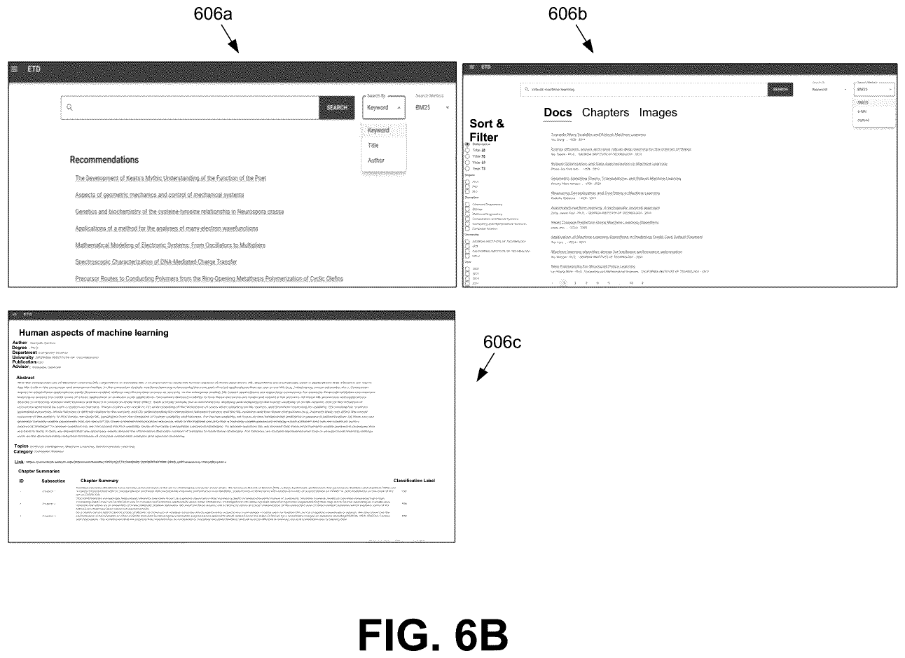

FIG. 6A illustrates a user interface 603a generated by the structured document access service 120. The user interface 603a can correspond to an ‘experimenter’ interface that enables a user to upload an ETD or electronic document 126, select a summarization model for the summarizer 218, select a classification model for the classifier 215, and submit the electronic document 126 to generate structured electronic document data 127. An object model for the object detection engine 121 and a topic model for the topic analyzer 212 can also be selected through another version of the user interface 603a.

FIG. 6A also illustrates a user interface 603b generated by the structured document access service 120 to perform experimental searches of the electronic documents 126 and the associated structured electronic document data 127. As can be seen, experiments corresponding to search queries and settings for the query can be stored and selected from a dropdown list or another predetermined listing of preformed experiments. A slider or other user interface elements can be used to select a weight of keyword search and a weight of vector search for an integrated search that uses a keyword model and a vector model to perform a search. A search can be 20% keyword and 80% vector as shown, or can be 50% keyword and 50% vector, or any other set of percentages that sum to 100%. A query can be entered through a query box user interface element, and a number of documents to return can be entered or selected in a corresponding interface element. A type of similarity can also be selected from a list of predetermined similarity types for the vector analysis, such as cosine similarity, Euclidean distance, or another type. Once performed, the search can show a list of electronic documents 126 (or other types of specified electronic document data 127, which can also be entered through the user interface 603b in other examples). Each electronic document 126 can be shown in a table in association with a document identifier and a search score, as shown in the bottom portion of 603b.

FIG. 6B illustrates a user interface 606a, 606b, and 606c generated by the structured document access service 120. This can be a search interface. Initially, the user interface 606a can show a search bar and user interface element that a user can manipulate to select which type of information to search using the user-entered query, from a list of predetermined information types such as “Keyword,” “Title,” “Author,” “All Fields” and so on. The user interface 606a can also show a user interface element that a user can manipulate to select which search method from a list of predetermined search methods to user for the search. The user interface 606a can also show a list of recommended electronic documents 126 and/or structured electronic document data 127, generated using a recommendation model as indicated above.

Once a search is performed, the user interface 606a can be updated to a user interface 606b. The user interface 606b can include a list of electronic documents 126 and a list of subsections 132 from the structured electronic document data 127 (and other types of structured electronic document data 127 such as objects, subsection summaries 136, and so on) can be populated. A selector can enable a user to select and view the list of electronic documents 126, the list of subsections 132, a list of objects, a list of subsection summaries 136, and so on. The user interface 606b can also show options to sort according to relevance, title, ascending year, descending year, and so on. The user interface 606b can also show options to filter according to degree type, discipline or department, university, year, and so on.

In an instance in which an electronic document 126 is selected, the user interface 606b can be updated to a user interface 606c, which shows structured electronic document data 127 for the electronic document 126. The user interface 606c can include a list of metadata extracted from the electronic document 126 such as author, degree, university, publication date, advisor name, discipline or department, and so on. The user interface 606c can include an abstract extracted and saved as an abstract object, a set of topics identified using the topic analyzer 212, a category or classification label 134 for the overall electronic document 126, and so on. The user interface 606c can include a link to the original electronic document 126. The user interface 606c can include a list of subsections 132, including for each: a subsection summary 136, a subsection number (or identifier), a link to a subsection 132 file, and a subsection classification label 134.

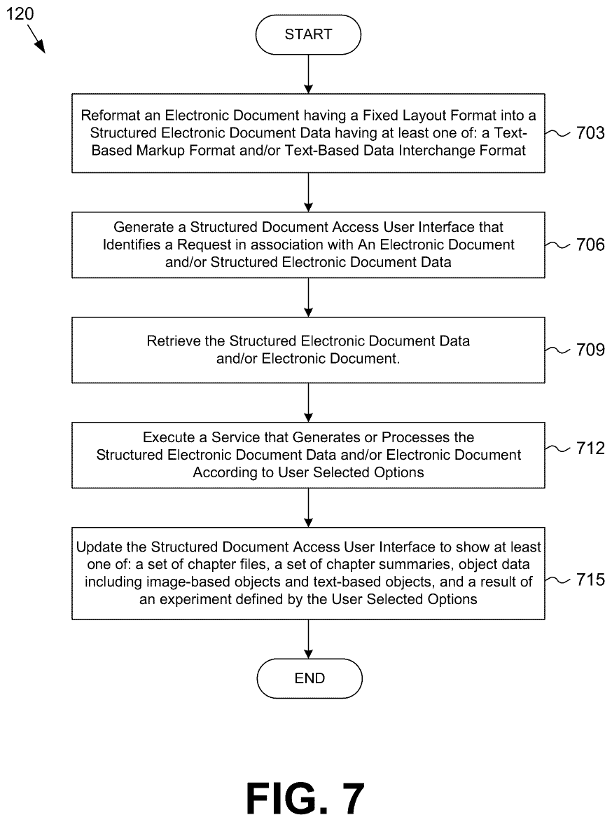

FIG. 7 shows a flowchart that illustrates aspects of the structured document access service 120 that provides structured document access. The flowchart can also be considered a method performed by the structured document access service 120.

In box 703, the structured document access service 120 can reformat an electronic document 126 into structured electronic document data 127. The electronic document 126 can have a fixed layout format such as a PDF file. The structured electronic document data 127 can include a version of the electronic document 126 that is formatted as a text-based file such as an XML file or a JSON file. This file can include the textual portions of the structured electronic document data 127 in a hierarchical and/or attribute-value format, and can include references to file names and/or locations of image-based objects or portions of the structured electronic document data 127.

In box 706, the structured document access service 120 can generate a structured electronic document access user interface. The structured document access service 120 can provide this user interface as a web application 227, a website, an application on a client device 109 that communicates with a server of the structured document access service 120, or another manner. The structured electronic document access user interface can identify a request for electronic documents 126 and/or structured electronic document data 127, that specifies a query string as well as other parameters and selections as discussed above, with respect to many of the previous figures and as shown in FIGS. 6A and 6B. In some examples, the request can include providing or uploading an electronic document 126 or a link to a location of an electronic document 126.

In box 709, the structured document access service 120 can retrieve structured electronic document data 127 and/or electronic documents 126 that correspond to the request. The structured document access service 120 can retrieve structured electronic document data 127 and/or electronic documents 126 from the datastore 124 or another network location.

In box 712, the structured document access service 120 can execute a service that processes the structured electronic document data 127 and/or electronic documents 126 according to user selected options. The structured document access service 120 can provide a number of different services through the user interface, including the ability to process electronic documents 126 into structured electronic document data 127 according to user selected options, search a repository of structured electronic document data 127 and/or electronic documents 126 according to user selected options, browse a repository of structured electronic document data 127 and/or electronic documents 126 according to user selected options, and other options as discussed herein.

In box 715, the structured document access service 120 can update the structured electronic document access user interface to show electronic documents 126 and/or structured electronic document data 127 corresponding to the request and according to the process performed. The structured electronic document data 127 can include at least one of: a set of chapter or subsection files, a set of chapter or subsection summaries 132, extracted object data 130 including image-based objects and text-based objects, and a result of an experiment defined by the user-based options. The text-based objects can be provided in a text-based file that also specifies or references an image-based object that is stored in association with the text-based file.

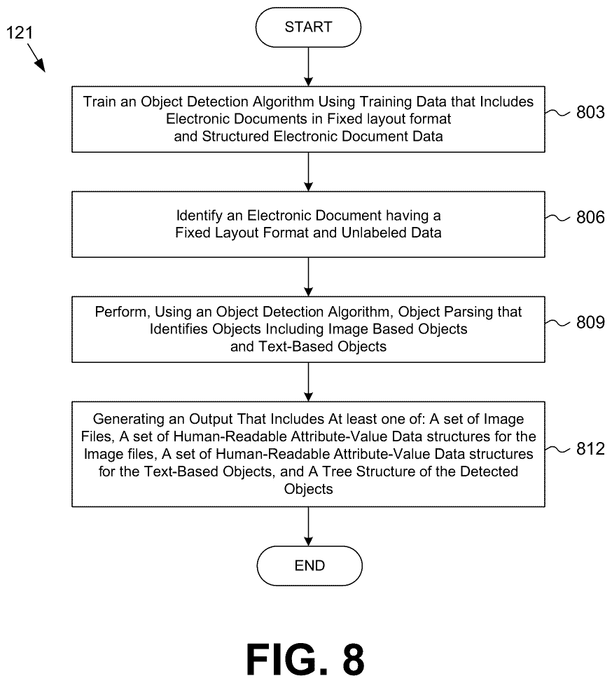

FIG. 8 illustrates a flowchart of the object detection engine 121. The flowchart can also be considered a method performed by the object detection engine 121. While discussed as being performed by the object detection engine 121, the flowchart can also be considered a method performed by the structured document access service 120, although generally directed to object detection aspects of the service.

In box 803, the object detection engine 121 can train an object detection algorithm such as a machine learning model to process electronic documents 126 to identify text-based objects and image-based objects therein and generate a structured electronic document file. The structured electronic document file can include text-based objects in a hierarchical and/or attribute-value format and can reference the image-based objects by identifier, file name, file location, and other data. The training can include providing a corpus of electronic documents 126 (e.g., corresponding to expected inputs) and structured electronic document data 127 (e.g., corresponding to expected outputs). The corpus can include files of a particular type or category.

In box 806, the object detection engine 121 can identify a particular electronic document 126 having a fixed layout format. For example, the electronic document 126 can include a PDF file, an image file, a set of image files, or another type of electronic document 126.

In box 809, the object detection engine 121 can perform, using the trained object detection algorithm or model, object parsing that identifies text-based extracted object data 130 and image-based extracted object data 130 in the electronic document 126. This can include creating bounding boxes around each object and types or categories of objects, including multiple types of text-based objects and multiple types of image-based objects. In some examples, a user interface can show an initial version of the bounding boxes around each object and the object labels. The user interface can identify user interactions that can modify the bounding boxes around each object and the object labels. The modifications can be provided as feedback to further train the object detection algorithm or model.

In box 812, the object detection engine 121 can generate an output that includes at least one of: a set of image files or objects, a set of human-readable (e.g., textual) attribute-value data structures for the image files or objects, a set of human-readable (e.g., textual) attribute-value data structures for the text-based objects, and a tree or hierarchical structure of the detected objects including at least one of text-based objects and image-based objects. The output can include a structured electronic document file that includes text-based objects in a hierarchical and/or attribute-value format, and can reference the image-based objects by identifier, file name, file location, and other data.

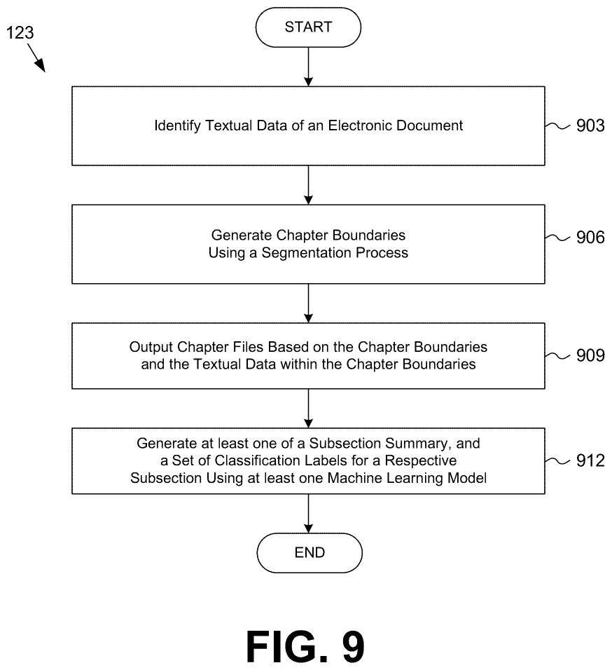

FIG. 9 illustrates a flowchart of a portion of the structured document access service 120, including segmentation engine 206, text extractor 203, and classification and summarization engine 123, for example, for segmentation, classification, summarization, and topic analysis. The flowchart can be considered a method performed by these portions of the structured document access service 120. While discussed as being performed by portions of the structured document access service 120, the flowchart can also be considered a method performed by the structured document access service 120, although generally directed to subsection processing aspects of the service including but not limited to segmentation, classification, summarization, and topic analysis.

In box 903, the segmentation engine 206 and text extractor 203 can identify textual data within pages from a fixed layout format electronic document 126. Additionally or alternatively, the specified electronic document 126 can include a set of pages in image format. This can be performed using OCR on page images or directly read from the electronic document 126 in an instance in which the electronic document is “born digital” and includes the text as textual data rather than as images of a PDF or other type of electronic document 126.

In box 906, the structured document access service 120 can identify chapter or subsection boundaries using a segmentation process such as the segmentation engine 206 or the object detection engine 121. The object detection engine 121 can identify objects and arrange them in a hierarchical data structure as seen in FIG. 3. This can include identifying chapter heading objects or other objects that indicate a beginning of a chapter. A page number or page number object can be associated with the chapter heading object, so the beginning boundary page of a chapter or other subsection 132 can be the page that includes the chapter heading object, and the end of the chapter can be the page before the next chapter heading object, and so on. An end of the chapter can also be detected from other types of subsection headings such as a glossary heading object, an abstract heading object, an index heading object, and so on.

In box 909, the structured document access service 120 can generate output of a set of subsection 132 files. Each of the subsections 132 can be associated with one or more files. The files for a subsection 132 can include a subsection 132 file in a fixed layout format, separated according to the subsection boundaries. The structured document access service 120 can also generate a text-based file that includes textual data for the subsection 132.

In box 912, the classification and summarization engine 123 can generate a subsection summary 136 for a subsection 132. A subsection summary 136 can refer to a summary generated using text extracted from a particular subsection 132. The classification and summarization engine 123 can include one or more language model, such as a natural language processing (NLP) model such as a large language model that processes text extracted from a particular subsection 132 and provided as input to the model. The model can output a subsection summary 136 for a respective subsection 132. The set of subsection summaries 136 can be included in a structured file such as a JSON file or an XML file that associates subsection 132 unique identifiers, classification labels 134, and other information with the subsection summary 136.

The various aspects of the disclosure can include systems methods and media for processing electronic documents by at least: generating, by a structured documentation access service, at least one user interface that identifies a user request for structured documentation from at least one electronic document; transmitting a request to access the structured documentation, wherein a subset of the structured documentation is retrieved based on the request; executing at least one service that processes the subset of the structured documentation based at least in part on a plurality of user selected options specified in the user request for structured documentation; updating the user interface to include at least one of: a plurality of chapter files, a plurality of chapter summaries for the plurality of chapter files using a summarization process, object data comprising image-based objects and text-based objects from the electronic document, a result of at least one experiment defined by the user request, or any combination thereof. The aspects can include processing the structured documentation according to a topic identification model to identify topics relevant to a plurality of subsets of the structured documentation. The aspects can include identifying the subset of the structured documentation based at least in part on a relationship identified between a topic of the subset of the structured documentation and data specified in the user request. The aspects can include exposing at least one application programming interface (API) that is invoked based at least in part on the user request. In some examples the at least one documentation request API is invoked based at least in part on user interaction with a webapp provided by the structured documentation access user interface. The aspects can include: exposing at least one documentation upload application programming interface (API) that enables users to upload the structured documentation. The aspects can include: receiving at least one documentation upload request that invokes the at least one documentation upload API; and storing the at least one electronic document as the structured documentation based at least in part on the at least one documentation upload request. In some examples, the chapter segmentation process comprises: identifying textual data within a plurality of page images of an electronic document comprising the page images; generating, by a classification model, a page classification label data structure that associates a respective page image of the plurality of page images of the electronic document to be associated with a classification label from a plurality of predetermined classification labels; identifying, by a chapter boundary process, a plurality of chapter boundaries based at least in part on the page classification label data structure; and providing an output comprising a plurality of chapter files generated based at least in part on the textual data and the plurality of chapter boundaries.

The aspects can include: systems, methods, and media for object detection for electronic documents, comprising: identifying an electronic document comprising unlabeled data; performing, using an object detection algorithm, object parsing to identify a plurality of objects comprising: a plurality of image-based objects, and a plurality of text-based objects; generating a plurality of refined objects by performing at least one modification to the plurality of objects; and providing an output comprising at least one of: a plurality of image files corresponding to the plurality of image-based objects, a first plurality of human-readable attribute-value based data structures corresponding to the plurality of image-based objects, a second plurality of attribute-value based data structures corresponding to the plurality of text-based objects, and a hierarchical structure file based at least in part on the plurality of detected objects. The aspects can include: training an object detection algorithm to identify objects corresponding to at least one object type comprising at least one image-based object type and at least one text-based object type. In some examples, the at least one image-based object type comprises a figure image type, an equation image type, a table image type, and an algorithm image type. In some cases, the at least one object type comprises at least one of image-based objects and text-based objects. In some examples, the tree structure comprises a plurality of text elements comprising the text-based objects, and a plurality of image paths that refer to the image-based objects. In some examples, providing the output comprises at least one of: storing the output in a database, and generating a user interface comprising the output. In some examples, the user interface is generated and included in a network site. In some examples, the at least one text-based object type comprises a chapter type, a caption type, and a heading type. In some examples, the training data includes labels generated using an AI-aided annotation framework.

The aspects can include: systems, methods, and media for segmentation of electronic documents, comprising: identifying textual data within a plurality of page images of an electronic document comprising the page images; generating, by a classification model, a page classification label data structure that associates a respective page image of the plurality of page images of the electronic document to be associated with a classification label from a plurality of predetermined classification labels; identifying, by a chapter boundary process, a plurality of chapter boundaries based at least in part on the page classification label data structure; and providing an output comprising a plurality of chapter files generated based at least in part on the textual data and the plurality of chapter boundaries.

The aspects can include: training the classification model to identify the plurality of predetermined classification labels based at least in part on training data for the plurality of predetermined classification labels. The aspects can include: parsing a chapter file of the plurality of chapter files; removing, from the chapter files, a plurality of elements comprising figures and tables identified in the chapter files; and saving a text file as a cleaned textual version of the chapter file that omits the figures and the tables. The aspects can include: generating, for a respective chapter of the plurality of chapters of the electronic document, a chapter summary based at least in part on a subset of the textual data comprising the respective chapter. In some examples, the chapter summary is generated using a cleaned textual version of a chapter file of the plurality of chapter files. In some examples, the chapter summary is generated using both unsupervised methods and transformer models that are pre-trained using an initial training dataset. The transformer model can also be iteratively fine-tuned using a training dataset that is specific to theses and dissertations, and can include documents with chapters; and the fine tuning training dataset can include documents specific to classifications.

The aspects can include: systems, methods, and media for classification and/or summarization for electronic documents, comprising: identifying textual data of an electronic document; generating, by a segmentation process, a plurality of chapter boundaries based at least in part on the textual data of an electronic document; and providing an output comprising a plurality of chapter files generated based at least in part on the textual data and the plurality of chapter boundaries. The aspects can include: as part of the segmentation process, generating, by a classification model, page classification labels from a set of predetermined classification labels using textual and/or page image information, as part of the segmentation process, training a segmentation model to identify a plurality of predetermined classification labels based at least in part on training data for the plurality of predetermined classification labels. The aspects can include: parsing a chapter file of the plurality of chapter files, removing, from the chapter files, a plurality of elements comprising figures and tables identified in the chapter files; and saving a text file as a cleaned textual version of the chapter file that omits the figures and the tables. The aspects can include: generating, for a respective chapter of the plurality of chapters of the electronic document, chapter labels from a set of predetermined classification labels based at least in part on the subset of textual data comprising the respective chapter. The aspects can include: generating, for a respective chapter of the plurality of chapters of the electronic document, a chapter summary based at least in part on a subset of the textual data comprising the respective chapter. In some examples, the chapter classification label and chapter summary are generated using a cleaned textual version of a chapter file of the plurality of chapter files. In some examples, the chapter classification label uses a transformer model that is pre-trained using an initial training dataset, and is iteratively fine-tuned using a training dataset that is specific to theses and dissertations. In some examples, the chapter summary is generated using both unsupervised methods and transformer models that are pre-trained using an initial training dataset.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are potential examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Flowcharts and sequence diagrams can show examples of the functionality and operation of implementations of components described herein. The components described herein can be embodied in hardware, software, or a combination of hardware and software. If embodied in software, each element can represent a module of code or a portion of code that includes program instructions to implement the specified logical function(s). The program instructions can be embodied in the form of, for example, source code that includes human-readable statements written in a programming language or machine code that includes machine instructions recognizable by a suitable execution system, such as a processor in a computer system or other system. If embodied in hardware, each element can represent a circuit or a number of interconnected circuits that implement the specified logical function(s).

Although flowcharts and sequence diagrams can show a specific order of execution, it is understood that the order of execution can differ from that which is shown. For example, the order of execution of two or more elements can be switched relative to the order shown. Also, two or more elements shown in succession can be executed concurrently or with partial concurrence. Further, in some examples, one or more of the elements shown in the flowcharts can be skipped or omitted.

The computing devices and other hardware components described herein can include at least one processing circuit. Such a processing circuit can include, for example, one or more processors and one or more storage devices that are coupled to a local interface. The local interface can include, for example, a data bus with an accompanying address/control bus or any other suitable bus structure.

The one or more storage devices for a processing circuit can store data or components that are executable by the one or more processors of the processing circuit. For example, the various executable software components can be stored in one or more storage devices and be executable by one or more processors. Also, a datastore can be stored in the one or more storage devices.

The functionalities described herein can be embodied in the form of hardware, as software components that are executable by hardware, or as a combination of software and hardware. If embodied as hardware, the components described herein can be implemented as a circuit or state machine that employs any suitable hardware technology. The hardware technology can include, for example, one or more microprocessors, discrete logic circuits having logic gates for implementing various logic functions upon an application of one or more data signals, application specific integrated circuits (ASICs) having appropriate logic gates, programmable logic devices (e.g., field-programmable gate array (FPGAs), and complex programmable logic devices (CPLDs)).

Also, one or more of the components described herein that include software or program instructions can be embodied in any non-transitory computer-readable medium for use by or in connection with an instruction execution system such as a processor in a computer system or other system. The computer-readable medium can contain, store, and/or maintain the software or program instructions for use by or in connection with the instruction execution system.

A computer-readable medium can include a physical media, such as, magnetic, optical, semiconductor, and/or other suitable media. Examples of a suitable computer-readable media include, but are not limited to, solid-state drives, magnetic drives, or flash memory. Further, any logic or component described herein can be implemented and structured in a variety of ways. For example, one or more components described can be implemented as modules or components of a single application. Further, one or more components described herein can be executed in at least one computing device or by using multiple computing devices.

As used herein, “about,” “approximately,” and the like, when used in connection with a numerical variable, can generally refer to the value of the variable and to all values of the variable that are within the experimental error (e.g., within the 95% confidence interval for the mean) or within +/−10% of the indicated value, whichever is greater.

Where a range of values is provided, it is understood that each intervening value and intervening range of values, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

It is emphasized that the above-described examples of the present disclosure are merely examples of implementations to set forth for a clear understanding of the principles of the disclosure. Many variations and modifications can be made to the above-described examples without departing substantially from the spirit and principles of the disclosure. All such modifications and variations are intended to be included herein within the scope of this disclosure.

Therefore, at least the following is claimed:

1. A system for processing electronic documents, the system comprising:
at least one computing device comprising at least one processor; and
at least one memory comprising instructions, wherein the instructions, when executed, cause the at least one processor to at least:
generate, by a structured documentation access service, at least one user interface comprising a predetermined set of user interface elements that are specific to a particular persona of a plurality of personas managed by the structured documentation access service, wherein the at least one user interface identifies a structured document request to search or generate structured documentation in association of at least one electronic document;
execute at least one service that processes the structured documentation, the at least one electronic document, or any combination thereof based at least in part on a plurality of user selected options specified in the structured document request based at least in part on user interactions with the predetermined set of user interface elements that are specific to the particular persona; and
update the user interface to include at least one of: a plurality of subsection files generated using a subsection processing engine, a plurality of subsection summaries generated for the plurality of subsection files using the subsection processing engine, object data comprising image-based objects and text-based objects generated from the electronic document using an object detection engine, a result of at least one experiment defined by the structured document request, or any combination thereof.

2. The system of claim 1, wherein the instructions, when executed, cause the at least one processor to at least:
process the structured documentation according to a topic identification model to identify topics relevant to a plurality of subsets of the structured documentation.

3. The system of claim 2, wherein the instructions, when executed, cause the at least one processor to at least:
identify the structured documentation based at least in part on a relationship identified between a topic of the structured documentation and data specified in the structured document request.

4. The system of claim 1, wherein the instructions, when executed, cause the at least one processor to at least:
expose at least one documentation request application programming interface (API) that is invoked based at least in part on the structured document request.

5. The system of claim 4, wherein the at least one documentation request API is invoked based at least in part on user interaction with a web application provided by the user interface.

6. The system of claim 1, wherein the subsection processing engine:
identifies textual data of an electronic document;
generates, by a segmentation process, a plurality of subsection boundaries based at least in part on the textual data of the electronic document; and
provides an output comprising at least one of: the plurality of subsection files, the plurality of subsection summaries, or any combination thereof.

7. The system of claim 1, wherein the object detection engine:
identifies an electronic document;
performs, using an object detection algorithm, object parsing to identify a plurality of objects comprising: the image-based objects, and the text-based objects.

8. A method for object detection for electronic documents, the method comprising:
identifying an electronic document;
performing, using an object detection algorithm, object parsing to identify a plurality of detected objects comprising: a plurality of image-based objects, and a plurality of text-based objects;
generating a plurality of refined objects by performing at least one modification to the plurality of detected objects; and
providing an output comprising at least one of:
a plurality of image files corresponding to the plurality of image-based objects,
a first plurality of human-readable attribute-value based data structures corresponding to the plurality of image-based objects,
a second plurality of attribute-value based data structures corresponding to the plurality of text-based objects,
a hierarchical structure file based at least in part on the plurality of detected objects, or any combination thereof.

9. The method of claim 8, further comprising:
training an object detection algorithm to identify objects corresponding to at least one object type comprising at least one image-based object type and at least one text-based object type.

10. The method of claim 9, wherein the at least one image-based object type comprises a figure image type, an equation image type, a table image type, and an algorithm image type.

11. The method of claim 9, wherein the at least one object type comprises at least one of: image-based objects, text-based objects, or any combination thereof.

12. The method of claim 8, wherein the hierarchical structure file comprises a plurality of text elements comprising the text-based objects, and a plurality of image file locations or paths that refer to the image-based objects.

13. The method of claim 8, wherein providing the output comprises at least one of: storing the output in a database, generating a user interface comprising the output, or any combination thereof.

14. The method of claim 8, wherein a user interface comprising the output is generated and included in a network site.

15. A non-transitory computer readable medium comprising instructions that when executed by at least one computing device, cause the at least one computing device to at least:
identify textual data of an electronic document;
generate, by a segmentation process, a plurality of subsection boundaries based at least in part on the textual data of the electronic document; and
provide an output comprising a plurality of subsection files generated based at least in part on the textual data and the plurality of subsection boundaries.

16. The non-transitory computer readable medium of claim 15, wherein the instructions, when executed by the at least one computing device, cause the at least one computing device to at least:
as part of the segmentation process, generate, by a classification model, page classification labels from a set of predetermined classification labels using textual information, page image information, or any combination thereof, and
as part of the segmentation process, train a segmentation model to identify a plurality of predetermined classification labels based at least in part on training data for the plurality of predetermined classification labels.

17. The non-transitory computer readable medium of claim 15, wherein the instructions, when executed by the at least one computing device, cause the at least one computing device to at least:
parse a subsection file of the plurality of subsection files;
remove, from the subsection files, a plurality of elements comprising figures and tables identified in the subsection files; and
save a text file as a cleaned textual version of the subsection file that omits the figures and the tables.

18. The non-transitory computer readable medium of claim 15, wherein the instructions, when executed by the at least one computing device, cause the at least one computing device to at least:
generate, for a respective subsection of the plurality of subsections of the electronic document, subsection labels from a set of predetermined classification labels based at least in part on a subset of textual data comprising the respective subsection.

19. The non-transitory computer readable medium of claim 15, wherein the instructions, when executed by the at least one computing device, cause the at least one computing device to at least:
generate, for a respective subsection of the plurality of subsections of the electronic document, using a subsection summarization process, a subsection summary based at least in part on a subset of the textual data comprising the respective subsection.

20. The non-transitory computer readable medium of claim 19, wherein at least one of the segmentation process, the subsection summarization process, or any combination thereof, uses a transformer model that is pre-trained using an initial training dataset, and is iteratively fine-tuned using a training dataset that is specific to theses and dissertations.
